(19) United States
(12) Patent Application Publication
(10) Pub. No.: US 2021/0406358 A1
(43) Pub. Date: Dec. 30, 2021

(54) SENSORS ACCESS CONTROL

(71) Applicant: HEWLETT-PACKARD DEVELOPMENT COMPANY, L.P., SPRING, TX (US)

(72) Inventors: LEE ATKINSON, TAIPEI CITY (TW); CHEN-FANG HSU, TAIPEI CITY (TW)

(21) Appl. No.: 16/483,384

(22) PCT Filed: Mar. 20, 2018
(86) PCT No.: PCT/US2018/023243

§ 371 Date: Aug. 2, 2019

(51) Int. Cl. G06F 21/44; G06F 21/62

(52) U.S. Cl. CPC G06F 21/44; G06F 21/6218

(57) ABSTRACT

Examples techniques to control access to sensors of computing devices are described. In an example, a request to access a data of a first sensor is received. A physical condition defined for permitting access to the data of the first sensor is determined via a second sensor. The access to the data of the first sensor is controlled based on the physical condition.

### BACKGROUND

User devices, such as laptops and tablets, comprise numerous sensors. For example, a user device may include proximity sensors to detect proximity of a user to the user device. The sensors enable various function of the user devices. For instance, inputs from the proximity sensors may be used to control the transmission power of a user device to comply with prescribed specific absorption rate (SAR) values. In another example, a user device may include biometric sensors to capture biometric data of a user for purposes, such as authentication of a user.

Similarly, other examples of sensors may include devices to capture images, videos, and audio inputs from a user. For example, a built-in camera of a computing device, such as webcam of a laptop, enables users to capture pictures or videos. In another example, a built-in microphone of the computing device allows users to record audio inputs.

### BRIEF DESCRIPTION OF FIGURES

The following detailed description references the drawings, wherein:

FIG. 1 illustrates a computing device comprising an access control module for controlling access to a sensor of the computing device, in accordance with an example;

FIG. 2 illustrates a computing device comprising an access control module for controlling access to a sensor of the computing device, in accordance with another example;

FIG. 3 illustrates a computing device comprising an access control module for controlling access to a sensor of the computing device, in accordance with yet another example;

FIG. 4 illustrates sensors of a computing device, in accordance with an example;

FIG. 5 illustrates a method for controlling access to a sensor of a computing device, according to an example; and

FIG. 6 illustrates a computing environment implementing a non-transitory computer-readable medium for controlling access to a sensor of a computing device, according to an example.

### DETAILED DESCRIPTION

Computing devices, such as desktops, laptops, and tablets, generally include various sensors that generate data based on interactions that users have with the computing devices or based on ambient conditions of the computing devices. Applications running on the computing devices may access the sensors to enable various functionalities of the computing devices. For instance, an application that controls a display of a computing device may access an ambient light sensor of the computing device to control the display in accordance with the ambient light; a voice over Internet protocol NOR) application running on a computing device may access the microphone of the computing device to allow a user to make a VOIP call; and an application providing a location-based service may access a GPS device of the computing device.

Generally, a computing device also connects to the Internet, making it vulnerable to malware applications that may be installed on the computing device by malicious users who may then access the data of the sensors through the malware applications. For example, by accessing data of an ambient light sensor of the computing device, a malicious user may determine as to when a user is awake or asleep. Similarly, data related to temperature or fan speed of the computing device can be spied upon to determine if a user has been using the computing device. In another example, a malware application may access the data of the GPS device to reveal the location of a user to a malicious user. Likewise, data of a camera and microphone may be accessed and transmitted to an external device. Such unauthorized accesses, without a user's knowledge, puts his privacy at stake.

In some cases, an operating system (OS) of the computing device may treat entrusted applications, whose source cannot be verified or trusted, as malware applications and disallow such applications from accessing the sensors. However, trusted applications may also be manipulated to gain unauthorized access to the sensors. Thus, generally, data of the sensors may be vulnerable to unauthorized accesses.

According to an example implementation of the present subject matter, techniques for controlling access to sensors of computing devices are described. The example methods and systems for controlling the access provide for prevention of an access attempted without the knowledge of the user.

In an example implementation, when a request to access data of a sensor of a computing device is received, a physical condition defined for permitting access to the data of the sensor is obtained. The access to the data of the sensor is controlled based on verification of the physical condition. In an example, the physical condition may be indicative of a condition in which use of the sensor may be an expected use, as opposed to a use without the knowledge of the user. For instance, when a request to access data of a camera is obtained, the ambient light may be expected to be above a threshold or a user may be expected to be in proximity of the computing device. Similarly, when a request to obtain data of an ambient light sensor is received, it may be expected that a display device of the computing device is switched ON or that a lid of the computing device is not closed. Verification of the physical conditions associated with expected use of a sensor to allow the access to the data of the sensor prevents a malware application from accessing the sensor.

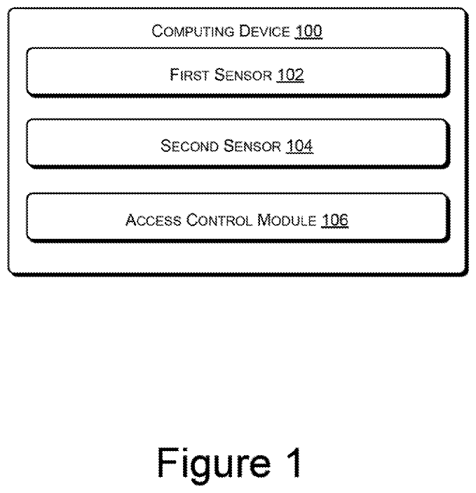

The above techniques are further described with reference to FIG. 1 to FIG. 6. It should be noted that the description and the Figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows an example computing device 100, according to an example. Examples of the computing device 100 include, but are not limited to, electronic device, such as a desktop computer, a laptop, a smartphone, a personal digital assistant (PDAs), and a tablet that may include or may be interfaced with a first sensor 102 and a second sensor 104.

According to an implementation of the present subject matter, the first sensor 102 may be a physical condition sensor or an operational state sensor while the second sensor 104 may be a physical condition sensor. A physical condition sensor may be understood as a device to detect a physical interaction or a physical condition associated with the computing device 100 and to generate data responsive to such interaction or condition.

Examples of the physical condition sensor comprise devices that generate data based on interaction of a user with the computing device 100, for example, a camera, microphone, and a biometric device; devices that detect an ambient condition of the computing device 100, such as an ambient light detector and an ambient temperature detector; devices that detect a location of the computing device 100, such as a global positioning system (GPS) device; devices that detect position or orientation of the computing device 100, for example, a compass, accelerometer, gyrometer, and a lid-detector that senses whether or not a display of the computing device 100 is covered with a lid; devices that detect an operating parameter of a component of the computing device, for instance, a central processing unit (CPU) temperature sensor, a battery temperature sensor, and power supply detector; and devices that detect a user to be in proximity of the computing device 100, for example, based on capacitive detection, infrared or time of flight optical sensing.

An operational state sensor may be used to detect an operational state of the computing device 100, For example, the operational state sensor may determine a state, such as idle, stand-by etc., of the computing device 100; identify if the computing device 100 is connected to a network or to an external device; identify applications installed or executing on the computing device 100; and determine settings or preferences that the user may have defined for sensors or applications.

In an example, the computing device 100 comprises an access control module 106. In operation, the access control module 106 receives a request to access data of the first sensor 102 of the computing device 100. Upon receiving the request, the access control module 106 determines a physical condition defined for permitting access to the data of the first sensor 102. In an example implementation, the physical condition is determined via the second sensor 104. Accordingly, the access control module 106 controls the access to the data of the first sensor 102 based on the determined physical condition.

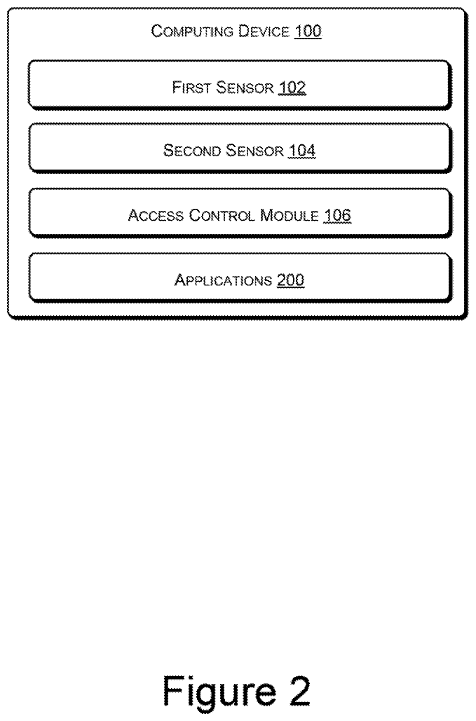

In accordance with another example which is illustrated in FIG. 2, to control access to the first sensor 102, the access control module 106 also determines applications 200 currently executing in the computing device 100. Accordingly, the access control module 106 allows the access to the first sensor 102 based on the applications 200 currently executing in the computing device 100 and a physical condition sensed by the second sensor 104.

Determining the applications 200 currently executing in the computing device 100 may include identifying properties of an application, such as a source of the application that may have requested the access to the first sensor 102. The physical condition, indicative of a condition in which the use of the first sensor 102 may be expected, may be assessed in conjunction with the identified application to allow the access to the first sensor 102. Properties of the identified application and corresponding physical conditions that establish that the use of the first sensor 102 is an expected use, as opposed to a spurious use that may be initiated by a malicious user, are elaborated subsequently.

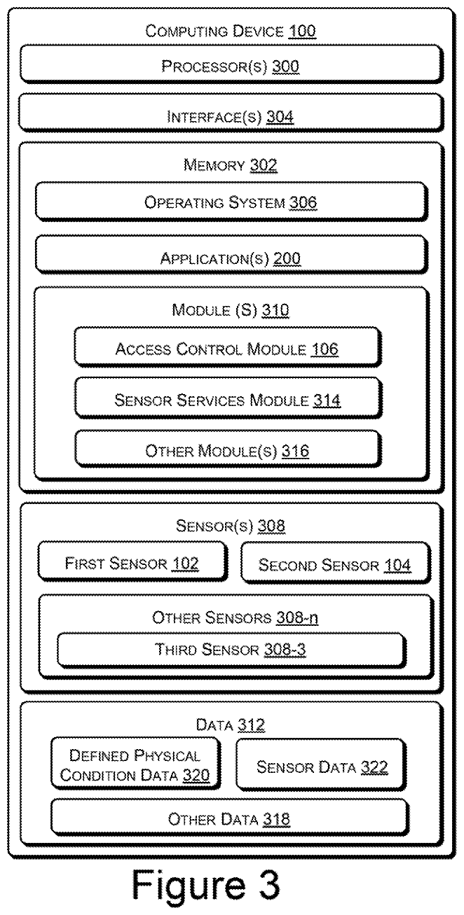

FIG. 3 illustrates a computing device comprising an access control module for controlling access to a sensor of the computing device, in accordance with yet another example.

The computing device 100, among other things, includes processor(s) 300 and memory 302 and interface(s) 304 coupled to the processor(s) 300. The processor(s) 300 may be implemented as microprocessors, microcomputers, microcontrollers, digital signal processors, central processing units, state machines, logic circuitries, and/or any devices that manipulate signals based on operational instructions. Among other capabilities, the processor(s) 300 is configured to fetch and execute computer-readable instructions stored in a memory 302 of the computing device 100. The system memory 302 may include any computer-readable medium including, for example, volatile memory (e.g., RAM), and/or non-volatile memory (e.g., EPROM, flash memory, etc.).

The functions of the various elements shown in the Figures, including any functional blocks labelled as “processor(s)”, may be provided through the use of dedicated hardware as well as hardware capable of executing software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other hardware, conventional and/or custom, may also be included.

A processor 300 hosts an operating system (OS) 306 of the computing device 100. The OS 306 is a set of instructions that manages the hardware and software of the computing device 100 to enable the computing device 100 to provide various services to the users. In an example, the OS 306 executes the applications 200 to provide various services to the user. An application 200 may be understood as a set of instructions to enable a functionality in the computing device 100. The application 200 may be either native to the OS 306 or may be a third-party application 200 installed on the OS 306. Examples of the application 200 include, but are not limited to, a VOIP application, video conferencing application, or a voice recorder application which can be executed by the OS 306 to provide functionalities, such as internet protocol (IP) based calling, video conferencing, and voice recording, respectively. Other examples of the application 200 include applications, for example, native applications that control an operation the computing device 100 based on an operating parameter of the computing device 100, such as a CPU throttling application that throttles the CPU based on a temperature of the CPU.

The applications 200 use sensors 308 to provide the corresponding functionalities. The sensors 308 include the first sensor 102, second sensor 104 and may additionally include other sensors 308-n, such as a third sensor 308-3. The interface(s) 304 may include a variety of software and hardware interfaces that allow the OS 306 to interact with the sensors 308.

Modules 310 and data 312 may reside in the memory 302. The modules 310 include routines, programs, objects, components, data structures, and the like, which perform particular tasks or implement particular abstract data types. In an example, the modules 310 include a sensor services module 314 in addition to the aforementioned access control module 106 as described with reference to FIGS. 1 and 2. The modules 310 may also comprise other modules 316 that supplement functions of the computing device 100.

The data 312 serves, amongst other things, as a repository for storing data that may be fetched, processed, received, or generated by the modules 310. The data 312 comprises other data 318 corresponding to the other modules 316. In the illustrated example implementation, the data 312 of the computing device 100 also comprises defined physical condition data 320 and sensor data 322.

In operation, when the access control module 106 receives a request to access data of the first sensor 102, for example, stored in sensor data 322, the access control module 106 determines the physical condition defined for permitting access to the data of the first sensor 102. In an example, the physical condition corresponding to each of the sensors 308 may be stored in defined physical condition data 320.

In an example implementation, the user may define the physical condition corresponding to each of the sensors 308. The physical condition defined by the user may be saved in the physical condition data 320. In another example, a manufacturer of the computing device 100 may define the physical condition for each of the sensors 308 as factory settings of the computing device 100. Further, the user of the computing device 100 may modify the setting or include new settings. For example, a first user that operates a computing device in a low ambient light condition, may define a first threshold for the ambient light to allow access a camera while a second user may define a second threshold that is lower than the first threshold to allow the access.

Accordingly, the access control module 106 may retrieve the physical condition defined for permitting access to the data of the first sensor 102. Based on the defined physical condition, a sensor, for example, the second sensor 104, of the computing device 100, that senses the defined physical condition, is determined. The sensor services module 314 communicates with the second sensor 104 identified corresponding to the defined physical condition and obtains an input regarding the defined physical condition from the second sensor 104. Thereupon, the access control module 106 assesses the input to allow access to data of the first sensor 102.

In an example implementation, the defined physical condition may be sensed by more than one sensor of the computing device 100. For instance, a determination of proximity of a user with the computing device 100 may be made by a capacitive proximity sensor of the computing device 100 as well as a sensor that senses that the user is interacting with an input/output device, such as a mouse, keyboard, and keypad of the computing device 100. Accordingly, the sensor services module 314 may communicate with more than one sensor, for example, the second sensor 104 as well as the third sensor 308-3.

Further, in an example implementation of the present subject matter, the sensor services module 314 may monitor the interaction of a user with the computing device 100 to determine if the user is in proximity to the computing device 100. The sensor services module 314 may determine the interaction based on inputs provided by the user to an I/O device of the computing device 100, for instance, a movement of a mouse or actuation of a key on a keyboard of the computing device 100. In an example, the sensor services module 314 may determine a time elapsed since the user last interacted with the computing device 100. If the elapsed time is more than a predetermined threshold, the sensor services module 314 may determine that the user is not in proximity to the computing device 100.

In some examples, a combination of physical conditions may be defined for permitting access to the data of the first sensor 102. For instance, in an example where the first sensor 102 is an image capturing device, the defined physical conditions may be a proximity of a user to the computing device 100 together with an ambient light that is above a threshold. In such cases too, the services module 314 may communicate with the second sensor 104 as well as the third sensor 308-3 that may be a capacitive proximity sensor and an ambient light sensor, respectively, in the instant example.

In examples where a combination of physical conditions may be used to control the access, a weightage may be assigned to each of the defined physical conditions. A combined weightage of the physical conditions may be determined by the access control module 106 to control the access. The weightage assigned to the each of the defined physical conditions may be unequal. Referring to the example where the first sensor 102 is an image capturing device, a higher weightage, say, ‘x’ may be assigned the physical condition of the proximity of the user to the computing device 100 than a weightage assigned to the physical condition of the ambient light being above the threshold. The combined weightage may be ‘x+y’ if both the physical conditions may be determined to be in the affirmative. Similarly, the combined weightage may be ‘x−y’ if the physical condition of the ambient light being above the threshold is not satisfied while the combined weightage may be ‘y−x’ if the physical condition of the proximity of the user to the computing device 100 is not satisfied.

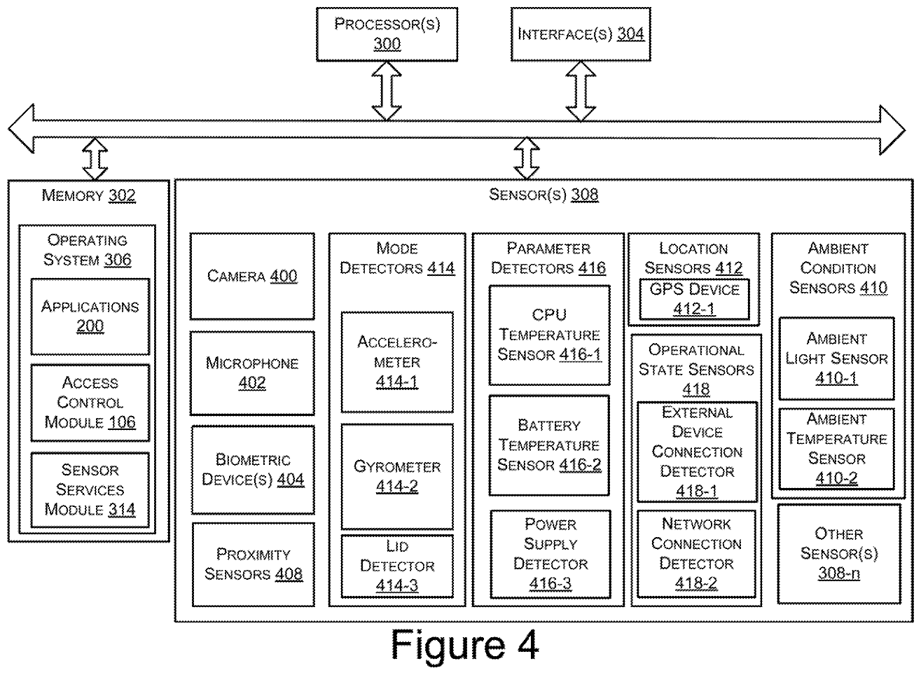

Examples of various sensors 308 and the corresponding physical conditions defined for the access is elaborated in reference to FIG. 4 that illustrates the computing device 100, in accordance with an example.

In accordance with an example implementation, the sensors 308 of the computing device 100 comprise I/O devices, for example, a camera 400, a microphone 402, and a biometric device 404 that detect an input of a user. The interface(s) 304 enables the communication between the I/O devices and the processor 300 of the computing device 100.

In an implementation, the sensors 308 may further comprise proximity sensors 408. Examples of the proximity sensors 408 comprise devices that sense the proximity based on capacitive detection, infrared or time of flight optical sensing or devices that sense the proximity based on interaction of the user with an I/O device of the computing device 100. In an example, the proximity sensors 408 are used to control a transmission power of an antenna of the computing device 100 to adhere with specific absorption rate (SAR) values that may be defined for the computing device 100, The data of the proximity sensors 408, if spied upon by a malicious application, may reveal whether a user is in the proximity of the computing device 100.

The sensors 308 further comprise ambient condition sensors 410. Examples of the ambient condition sensors 410 comprise ambient light sensor 410-1 and an ambient temperature sensor 410-2. The ambient light sensor 410-1 may be used for functions, such as controlling brightness of a LCD display of the computing device 100. Similarly, the ambient temperature sensor 410-2 may be used to control a cooling mechanism, such as a fan of the computing device 100. The data of the ambient light sensor 410-1 may indicate if a user is awake or asleep. In a similar manner, the data of the ambient temperature sensor 410-2 may reveal whether a user is in temperature-controlled environment, for example, indoor or outdoor.

The location sensors 412 included in the sensors 308 indicates a location of the computing device 100. Examples of the location sensors 412 comprise a GPS device 412-1. The GPS device 412-1 tracks the location of the computing device 100 in order to provide various location-based services to the user, such as location of nearby restaurants, location of hospitals, navigation and any other such services. The data of the GPS device 412-1 is indicative of a real-time location of the user.

In an example, the sensors 308 also comprise mode detectors 414 to determine a position or orientation of the computing device 100. The mode detectors 414 may include an accelerometer 414-1, a gyrometer 414-2, etc., that enable changing orientation of a displayed content in accordance with the orientation of the computing device 100. The data of the mode detectors 414 may determine if the computing device 100 is in a usable or an unusable condition. For instance, the accelerometer 414-1 and gyrometer 414-2 may determine the computing device 100 to be in an upside-down position and hence in an unusable condition.

The mode detectors 414 may also include a lid-detector 414-3 that comprises, for example, a magnetic sensor to determine a display of the computing device 100 to be covered with a lid. The lid-detector 414-3 indicates if the display is covered with a lid or not. When the lid-detector 414-3 indicates that the display is covered, it is expected that the computing device 100 is not in use. Accordingly, the computing device 100 may be put in an idle or standby state. While, when the computing device 100 is in use, the lid-detector 414-3 indicates that the display is not covered and hence, the computing device 100 is being used. Thus, the data of the lid-detector 414-3 may be used by a malicious user to learn whether a computing device 100 is being used by a user or if the computing device 100 is in idle or standby state.

Further, the sensors 308 of the computing device 100 may also include parameter detectors 416 that detect operating parameters associated with various components of the computing device 100, for instance, a CPU temperature sensor 416-1, a battery temperature sensor 416-2, and power supply detector 416-3. The CPU temperature sensor 416-1 indicates the temperature data of the CPU which is further utilized to manage the cooling system of the CPU. A low or negligible CPU temperature may indicate that the computing device 100 is not being used and is in idle or standby or sleep mode whereas a relatively high CPU temperature may indicate the computing device 100 is being used. Thus, the data of the CPU temperature sensor 416-1 may reveal if the computing device 100 is being used or not. Further, the data of the CPU temperature sensor 416-1 may in some case also indicate if the computing device 100 is performing a processor-intensive task.

Similarly, the battery temperature sensor 416-2 data may also indicate if the computing device 100 is in use. Furthermore, a power supply detector 416-3 of the computing device 100 indicates whether the computing device 100 is connected to a power source or not. In an example, the data of the power supply detector 416-3 may indicate if the user is indoor. A malicious user may track the data of the CPU temperature sensor 416-1, battery temperature sensor 416-2, or power supply detector 416-3 or a combination thereof to learn about a user's pattern of usage of the of the computing device 100.

In accordance with an implementation, the sensors 308 also comprise operational state sensors 418 in addition to the above described sensors that determine physical conditions. The operational state sensors 418 may comprise, for example, an external device connection detector 418-1 and network connection detector 418-2. The external device connection detector 418-1 provides details of the external devices, such as hard disk drive, scanner, camera etc., connected to the computing device 100 such that the computing device 100 may be able to configure the external devices for use. Thus, the external device connection detector 418-1 data can reveal details about the external devices connected to the computing device 100. Further the network connection detector 418-2 provide details of the network connection being used by the computing device 100 and accordingly the network connection detector 418-2 data may indicate the details of the network, including the location of the network, the computing device 100 is connected to.

According to an implementation of the present subject matter, the physical condition sensors as well as the operational state sensors may be hardware sensors, software-based sensing engines or a combination thereof.

As apparent from the foregoing description, a data of any of the sensors 308 may be requested by an application 200. The access control module 106 assesses the physical conditions defined for allowing access to the requested data. The sensor services module 314 communicates with the corresponding sensors 308 to obtain the inputs relating to the defined physical conditions. The access control module 106 allows the access based on verification of the physical conditions.

For example, if the application 200 requests an access to the data of the CPU temperature sensor 416-1, the access control module 106 assess the physical condition defined for allowing the access to the CPU temperature data. The defined physical condition may be a certain threshold of ambient light and uncovered display, in an example. The access control module 106 may determine, using ambient light senor 410-1, the ambient light condition of the computing device 100. Further, the access control module 106 may also determine, using the lid-detector 414-3, whether the display of the computing device 100 is covered or not. If it is determined by the access control module 106 that the ambient light is below a defined threshold and the display is covered, the physical condition may be assessed to not be satisfied and thus, the access control module 106 may not allow the application 200 to access the CPU temperature data. Further, in an example, the access control module 106 may display a notification that an attempt to access the CPU temperature data and the access was denied. The display notification may comprise a snapshot of the details of the application 200 and the time of requesting the access.

Further, in an example, the application 200 may request an access to the data of location sensors 412. Similar to the above example, the access control module 106 verifies whether the defined physical condition for providing the access to the location data is satisfied or not. The defined physical condition may be availability of user in front of the computing device 100, availability of user interfaces command from I/O devices such as mouse, keyboard etc. The access control module 106 accesses the data of the proximity sensor 408 to determine the availability of the user and may further determine if there are any input commands through the keyboard or mouse. Based on the data of the proximity sensor and the user interfaces command from I/O devices, if the access control module 106 determines that the physical condition is satisfied, the application 200 is granted access to the location data. Further, in an example, the access control module 106, upon verification of the physical condition, may provide a prompt to the user indicating that the application 200 is requesting data of location sensor 412 and the user can thereafter grant the request.

Further, as discussed above, a malicious user may also attempt to tap the data of the operation state sensors 418 to gain details of state of the computing device, i.e., active, idle or standby; external devices connected to the computing device 100; or details of the network to which the computing device 100 may be connected. For example, an application 200 may request an access to the data of network connection detector 418-2. To prevent unauthorized accesses to data of the operation state sensors 418, the access control module 106 analyzes the physical condition for allowing such access. In an example, the physical condition may be availability of inputs from the I/O devices or that the computing device 100 be in motion. Accordingly, to allow the request of the application, the access control module 106 analyzes the computing device 100 for inputs of any 110 devices, such as keyboard, mouse etc., as well as the data of the accelerometer 414-1.

According to an implementation of the present subject matter, to control the access to the data of the sensors 308, along with the analyzing the physical conditions, the access control module 106 may also determine applications 200 currently executing in the computing device. In an example, the access control module 106 may analyze a respective source of the applications 200 that are running on the computing device 100. For example, the access control module 106 can verify if the applications 200 are from trusted sources. Further, in an example, the access control module 106 may also check if an application 200 running on the computing device 100 is a native application or a third-party application. The access control module 106 can thereafter use the physical condition in conjunction with the additional information of the applications 200 to determine the access to the data of the sensors 308.

For example, when an access to the data of an ambient light sensor 410-1 is requested, the access control module 106 may analyze the physical condition of the computing device 100 and as well as identify the application initiating the request. If the access control module 106 identifies that the physical condition, for example, the display being in a switched ON state, is satisfied and the application requesting the access is a native application, the access control module 106 may approve the application to access the data of the ambient light sensor 410-1. While, if the access control module 106 identifies that the application requesting the access is a third-party application, the access control module 106 may deny the access even if the physical condition is satisfied.

In another example implementation, the access control module 106 may also determine an application initiated by a user in the computing device 100 at the time of receipt of a request to access the data of a sensor 308. In some cases, an application may be initiated by the user by providing a conspicuous input by the user. For instance, the user may operate a hardware switch to turn ON the camera 400 or microphone 402 coupled to the computing device 100. In such cases, where a conspicuous input by the user indicates that the request to access the data of the sensor is an expected use, the determined physical condition may be ignored. Further, in some examples, if the time elapsed since the interaction of a user with the computing device 100 is within a threshold, the physical condition may be outweighed.

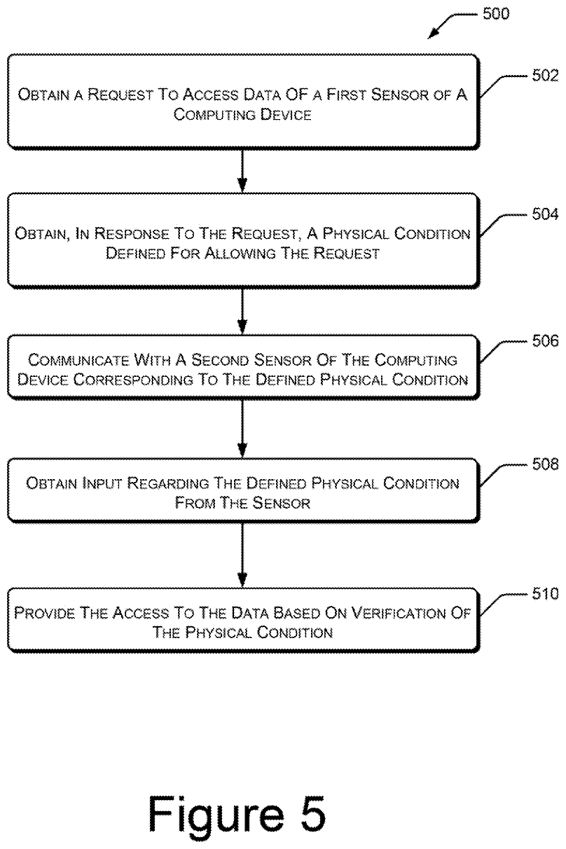

FIG. 5 illustrates a method 500 for controlling access to a sensor, for example, the first sensor 102 of a computing device, according to an example. Although the method 500 and may be implemented in a variety of electronic devices, for the ease of explanation, the present description of the example method 500 to control access of an application to sensor data is provided in reference to the above-described computing device 100.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine readable instructions, or combination thereof.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 5, at block 502, a request to access data of a sensor, for example, the first sensor 102 of the computing device 100 is received. In an example, the first sensor 102 may be any of the sensors 308 described with reference to FIG. 4. The first sensor 102 may include operation state sensors 418 that detect the operation state of the computing device 100. The request to access data of first sensor 102 is received by an access control module, such as access control module 106.

At block 504, the access control module 106 obtains the physical condition defined for allowing the access. As explained earlier, corresponding to each of the sensors 308 of the computing device 100, a physical condition or a combination of physical conditions may be defined for permitting the access. Thus, the access control module 106 may obtain the defined physical condition corresponding to the first sensor 102. In an example, the physical condition comprises proximity of a user with the computing device 100, an ambient condition associated with the computing device 100, a location of the computing device 100, a mode of the computing device 100, or a combination thereof, wherein the mode is based on a position or orientation of the computing device. After obtaining the physical condition, the method proceeds to block 506.

At block 506, the access control module 106 communicates with a second sensor 104 of the computing device 100 to obtain information about the defined physical condition. As apparent from the foregoing description, the second sensor 104 is to sense the defined physical condition. The corresponding input from the second sensor 104 regarding the physical condition is obtained at block 508. At block 510, the access control module 106 verifies the obtained physical condition and upon successful verification of the physical condition, the access control module 106 allows the application to access the sensor data.

To explain the above method with an example, the first sensor 102 may be an audio capturing device, such as the microphone 402 and the physical condition defined for allowing access to the microphone 402 may be proximity of a user to the computing device. Accordingly, in the present example, the physical condition to be assessed by the access control module 106 is the proximity. Thus, the access control module 106 may obtain an input indicative of the proximity from the second sensor 104. For example, the access control module 106 may determine the proximity based on the audio inputs captured an audio capturing device, such as the microphone 402. Further in another example, the access control module 106 may determine the proximity based on a visual input, such as presence of a face or iris, captured by an image capturing device, such as the camera 400. As apparent, the second sensor 104 may be any of the sensors 308 that may provide an input that may be assessed to sense the defined physical condition. Based on an assessment of the input of the second sensor 104, the access to the microphone 402 may be allowed if the user is sensed to be in the proximity. However, if the assessment of the input of the second sensor 104 indicates that the user is not in the proximity, the access to the microphone 402 may be denied. Also, the user may be notified of attempted access, for example, by way of an alert that may be displayed or by registering the attempted access in a log retrievable by the user.

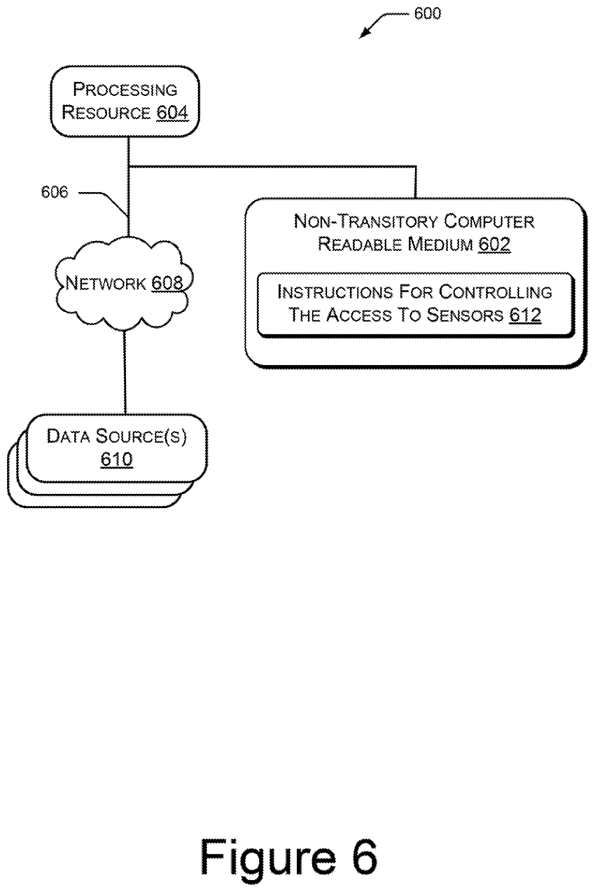

FIG. 6 illustrates a computing environment 600 implementing a non-transitory computer-readable med turn 602 for controlling access to a sensor of a computing device, according to an example. In an example implementation, the computing environment 600 may comprise a computing device having sensors, such as computing device 100 having the above described sensors 308. The computing environment 600 includes a processing resource 604 communicatively coupled to the non-transitory computer-readable medium 602 through a communication link 606. In an example, the processor resource 604 may be a processor of the computing device, such as the processor 300 of the computing device 100, that fetches and executes computer-readable instructions from the non-transitory computer-readable medium 602.

The non-transitory computer-readable medium 602 can be, for example, an internal memory device or an external memory device. In an example implementation, the communication link 606 may be a direct communication link, such as any memory read/write interface. In another example implementation, the communication link 606 may be an indirect communication link, such as a network interface. In such a case, the processing resource 604 can access the non-transitory computer-readable medium 602 through a network 608. The network 608 may be a single network or a combination of multiple networks and may use a variety of different communication protocols.

The processing resource 604 and the non-transitory computer-readable medium 602 may also be communicatively coupled to data sources 610. The data source(s) 610 may be used to store the physical conditions defined for the sensors of the computing device, in an example. In an example implementation, the non-transitory computer-readable medium 602 comprises executable instructions 612 for controlling the access to the sensors of the computing device. For example, the non-transitory computer-readable medium 602 may comprise instructions executable to implement the previously described access control module 106 and sensor services module 314.

In an example, when a request to access data of a sensor is obtained, the instructions 612 cause the processing resource 604 to obtain a physical condition corresponding to the sensor from the data source 610. As mentioned before, the sensor may be an operation state sensor, such as any of the operation state sensors 418. Accordingly, the data of the sensor may also include data relating to an operation state of the computing device. As apparent from the previous description, examples of data relating to the operation state of the computing device include, but are not limited to, identity of a network or an external device to which the computing device may be connected; data pertaining to applications installed or executing on the computing device; data pertaining to settings or preferences that a user may have defined for sensors or applications of the computing, device; and data regarding a state, such as idle, stand-by etc., of the computing device.

Thereafter, the instructions 612 cause the processing resource 604 to verify the physical condition and upon successful verification allow the access to the data. In an example, to obtain and verify the physical condition, the instructions 612 cause the processing resource 604 to communicate with a sensor of the computing device that senses the defined physical condition. The instructions 612 cause the processing resource 604 to obtain an input regarding the defined physical condition from the sensor that senses the defined physical condition and verify the physical condition based on the input to allow or deny the access to the data.

Verification of the physical condition provides for avoiding situations where a malware application may attempt to access the data relating to the operational state and other sensor data. Also, the instructions may cause the processing resource 604 to capture the details of the attempted access and a malware application associated therewith to display a notification indicating that the attempted access was denied.

Thus, the methods and systems of the present subject matter provide for controlling the access to the data of the sensors. Although implementations of controlling the access have been described in a language specific to structural features and/or methods, it is to be understood that the appended claims are not necessarily limited to the specific features or methods described. Rather, the specific features and methods are disclosed as example implementations for communicating the system events.

1. A computing device comprising:
a first sensor;
a second sensor; and
an access control module to:
receive a request to access data of the first sensor;
determine, via the second sensor, a physical condition, wherein the physical condition is for permitting access to the data of the first sensor; and
control the access to the data the first sensor based on the determination.

2. The computing device as claimed in claim 1, wherein the access control module is to further determine an application initiated by a user in the computing device.

3. The computing device as claimed in claim 1, wherein the physical condition comprises proximity of a user to the computing device, an ambient condition associated with the computing device, a location of the computing device, a mode of the computing device, or a combination thereof, wherein the mode is based on a position or orientation of the computing device.

4. The computing device as claimed in claim 1, wherein the first sensor comprises a biometric device, a global positioning system (GPS) device, a compass, a network connection detector, an accelerometer, a gyrometer, an ambient light sensor, an ambient temperature sensor, a central processing unit (CPU) temperature sensor, a battery temperature sensor, a power supply detector, a camera, a microphone, or an external device connection detector.

5. The computing device as claimed in claim 1, wherein the first sensor comprises an operational state sensor to detect an operational state of the computing device.

6. A computing device comprising:
a first sensor;
a second sensor; and
an access control module to control access to the first sensor, wherein the access control module is to:
determine applications currently executing in the computing device;
assess an input of the second sensor, wherein the second sensor is to sense a physical condition; and
allow access to the first sensor based on the determination and the sensed physical condition.

7. The computing device as claimed in claim 6, wherein to allow access to the first sensor, the access control module is to further:
receive an input of a third sensor of the computing device; and
determine a weightage assigned to the input of each of the second sensor and third sensor.

8. The computing device as claimed in claim 6, wherein the input is indicative of proximity of a user to the computing device or ambient conditions of the computing device.

9. The computing device as claimed in claim 8, further comprising sensor services module, wherein the sensor services module is to:
determine an interaction of the user with the computing device;
compute a time elapsed since the interaction; and
identify the user to be in the proximity to the computing device if the time elapsed is within a threshold.

10. The computing device as claimed in claim 6, wherein the first sensor is an image capturing device, and wherein the input is indicative of proximity of a user to the computing device or an ambient light associated with the computing device to be above a threshold.

11. The computing device as claimed in claim 6, wherein the first sensor is a parameter detector to detect an operating parameter of a component of the computing device, and wherein the determined applications comprise an application that controls an operation the computing device based on the operating parameter.

12. The computing device as claimed in claim 6, wherein the first sensor is an ambient light detector, and wherein the determined applications comprise an application that controls a display device coupled to the computing device.

13. The computing device as claimed in claim 6, wherein the sensor is a location sensor, and wherein the determined applications comprise an application providing a location-based service.

14. A non-transitory computer-readable medium comprising instructions executable by a processing resource to:
obtain, in response to a request to access data relating to an operational state of a computing device, a physical condition defined for permitting access to the data; and
control the access to the data based on verification of the physical condition.

15. The non-transistor computer-readable medium as claimed in claim 14, further comprising instructions executable to:
communicate with a sensor of the computing device corresponding to the defined physical condition; and
obtain an input regarding the defined physical condition from the sensor.
